(19) United States
(12) Patent Application Publication
(10) Pub. No.: US 2025/0273375 A1
(43) Pub. Date: Aug. 28, 2025

(54) DETENT SOLENOID

(71) Applicant: Schaeffler Technologies AG & Co. KG, Herzogenaurach (DE)

(72) Inventors: Peter Burke, Charlotte, NC (US); Brian Lee, Charlotte, NC (US); Carsten Behler, Wooster, OH (US)

(73) Assignee: Schaeffler Technologies AG & Co. KG, Herzogenaurach (DE)

(21) Appl. No.: 18/588,136

(22) Filed: Feb. 27, 2024

(51) Int. Cl. H01F 7/17; H01F 7/08

(52) U.S. Cl. CPC H01F 7/17; H01F 7/081; H01F 2007/086

(57) ABSTRACT

A detent solenoid includes an armature assembly with a groove, a coil arranged for displacing the armature assembly, and a detent arranged for seating in the groove. In an example embodiment, the groove includes a first axial side having a toroidal shape and a second axial side, opposite the first axial side, having a conical shape. In some example embodiments, the armature assembly includes an armature and a shaft fixed in the armature, and the groove is disposed in the shaft. In an example embodiment, the armature is made of a ferrous material.

### TECHNICAL FIELD

The present disclosure relates generally to a solenoid, and more specifically to a detent solenoid.

### BACKGROUND

Solenoids are known. One example is shown and described in commonly-assigned U.S. Pat. No. 9,443,649 titled COIL AND SOLENOID VALVE to Hoppe et al., hereby incorporated by reference as if set forth fully herein.

### SUMMARY

Example embodiments broadly comprise a detent solenoid including an armature assembly with a groove, a coil arranged for displacing the armature assembly, and a detent arranged for seating in the groove. In an example embodiment, the groove includes a first axial side having a toroidal shape and a second axial side, opposite the first axial side, having a conical shape. In some example embodiments, the armature assembly includes an armature and a shaft fixed in the armature, and the groove is disposed in the shaft. In an example embodiment, the armature is made of a ferrous material.

In some example embodiments, the detent solenoid also includes a housing at least partially surrounding the coil, a cover plate fixed to the housing, and a shaft pilot fixed to the cover plate. The shaft pilot has a radial hole and the detent is disposed in the radial hole. In an example embodiment, the cover plate includes an axially oriented hole with a radially extending notch, and at least a portion of the detent is disposed in the radially extending notch. In an example embodiment, the cover plate includes a radially outer notch and the housing includes a tab folded over the radially outer notch to fix the cover plate to the housing. In an example embodiment, the detent includes a detent housing fixed in the radial hole, a ball disposed in the detent housing, and a spring arranged to urge the ball into the groove.

In some example embodiments, the armature assembly includes an armature and, when the coil is energized, at least a portion of the armature is surrounded by the shaft pilot. In an example embodiment, the shaft pilot includes a first conical protrusion with a conical inner surface, and the armature includes a second conical protrusion with a conical outer surface disposed proximate the conical inner surface when the coil is energized. In some example embodiments, the detent solenoid also includes a return spring. The armature assembly includes an armature, the return spring is arranged axially between the armature and the shaft pilot, and the return spring is arranged to urge the armature assembly towards a rest position. In an example embodiment, the armature and the shaft pilot include respective cylindrical depressions and, in the rest position, a length of the return spring is less than a distance between the respective cylindrical depressions. In an example embodiment, when the coil is energized, the armature is axially displaced towards the shaft pilot, compressing the return spring.

In some example embodiments, the detent is seated in the groove when the armature assembly is in a rest position. In an example embodiment, when the coil is energized, the armature assembly is displaced and the detent is radially displaced out of the groove and rests against the armature assembly. In an example embodiment, the detent solenoid also includes a drawn sleeve fixed in the coil and arranged to guide the armature assembly. In an example embodiment, the detent solenoid also includes a second detent. The detent and the second detent are disposed circumferentially opposite one another, and respective central axes of the detent and the second detent are aligned so that radial forces from the detent and the second detent acting on the armature assembly are balanced.

### BRIEF DESCRIPTION OF THE DRAWINGS

FIG. 1 illustrates an exploded view of an example embodiment of a detent solenoid.

FIG. 2 illustrates a perspective view of the detent solenoid of FIG. 1.

FIG. 3 illustrates an end view of the detent solenoid of FIG. 1.

FIG. 4 illustrates a cross-sectional view of the detent solenoid of FIG. 1 taken generally along line 4-4 in FIG. 3.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

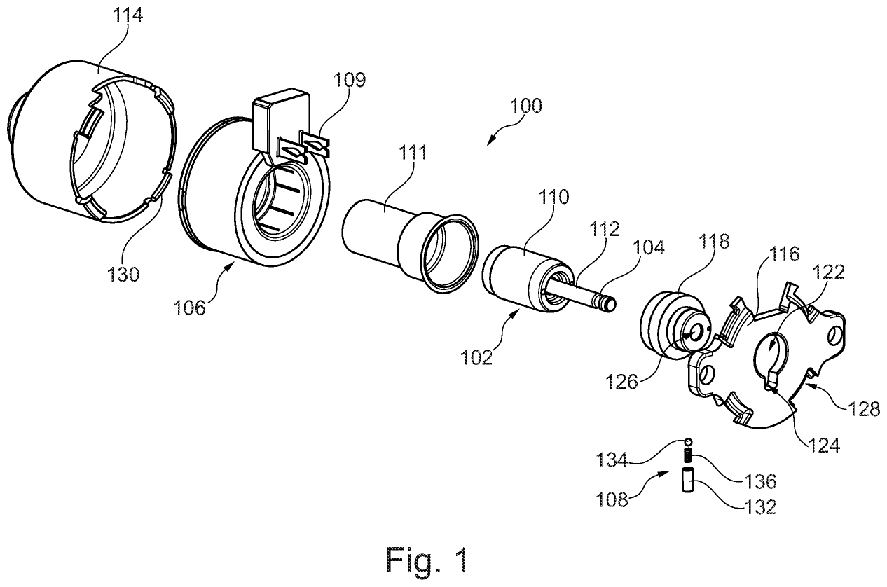

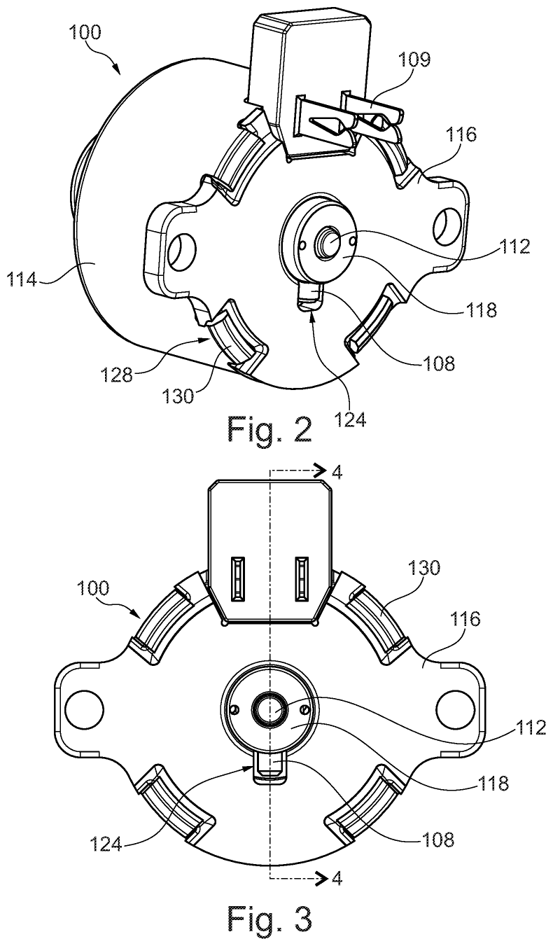

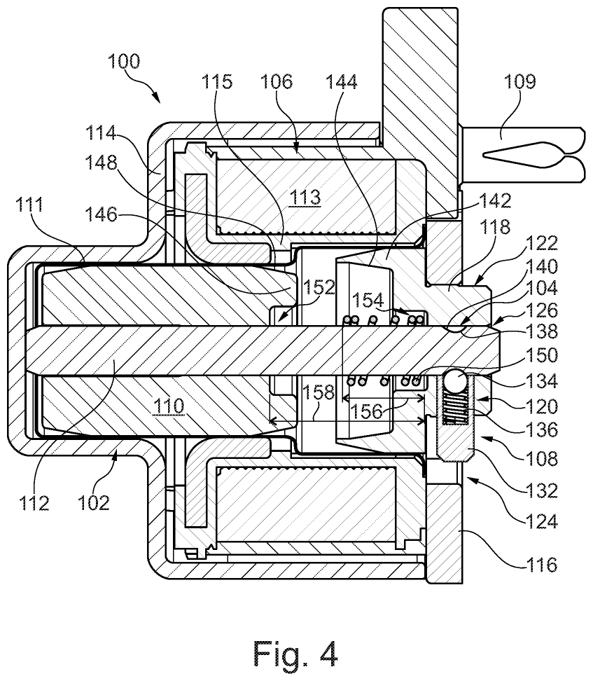

The following description is made with reference to FIGS. 1-4. FIG. 1 illustrates an exploded view of detent solenoid 100. FIG. 2 illustrates a perspective view of detent solenoid 100 of FIG. 1. FIG. 3 illustrates an end view of detent solenoid 100 of FIG. 1. FIG. 4 illustrates a cross-sectional view of detent solenoid 100 of FIG. 1 taken generally along line 4-4 in FIG. 3. Detent solenoid 100 includes armature assembly 102 with groove 104, coil 106 arranged for displacing the armature assembly, and detent 108 arranged for seating in the groove. Coil 106 includes electrical connector 109 arranged for receiving an electric current to energize to the coil and displace the armature assembly as described below. Armature assembly 102 includes armature 110 and shaft 112 fixed in the armature. The shaft 112 may be fixed in the armature by press-fitting, adhesive, or welding, for example, and may be arranged to operate an external mechanism (not shown). Detent solenoid 100 also includes drawn sleeve 111 fixed in the coil and arranged to guide the armature assembly.

In the embodiment shown, groove 104 is disposed in the shaft, though other locations of groove 104 in armature assembly 102 (e.g., groove 104 in armature 110) are possible. Armature 110 is made of a ferrous material so that, when coil 106 is energized, armature 110 is displaced in a known manner. In other words, because coil 106 includes wire coil 113 wrapped around bobbin 115 surrounding the armature, an electromagnetic field is produced around the armature when the wire coil is energized by an electric current and, when viewed in the orientation shown in FIG. 4, the armature assembly moves to the right.

Detent solenoid 100 also includes housing 114 at least partially surrounding coil 106, cover plate 116 fixed to the housing (as described below), and shaft pilot 118 fixed to the cover plate. Shaft pilot 118 includes radial hole 120 and detent 108 is disposed in the radial hole. Cover plate 116 includes axially oriented hole 122 with radially extending notch 124 and at least a portion of detent 108 is disposed in the radially extending notch. Shaft pilot 118 extends through hole 122 and shaft 112 extends through and is piloted by hole 126 in shaft pilot 118, coaxial with hole 122. Cover plate 116 includes radially outer notch 128 and housing 114 includes tab 130 folded over the radially outer notch to fix the cover plate to the housing.

Detent 108 includes detent housing 132 fixed in radial hole 120, ball 134 disposed in the detent housing, and spring 136 arranged to urge the ball into the groove. When the detent is assembled, the spring and ball are installed in the housing and compressed, and an axially distal end of the housing is partially folded over to retain the ball so that, in a rest position, the ball protrudes slightly from the housing. When installed in detent solenoid 100, the portion of the ball protruding from the housing extends into the groove when the solenoid is in a rest position. The ball prevents undesirable axial displacement of the shaft when the detent solenoid is not actuated. Groove 104 is not symmetric and includes axial side 138 having a toroidal shape and axial side 140, opposite axial side 138, having a conical shape. The angle of the cone in axial side 140 can be adjusted to allow easier removal from the ball from the groove, or harder removal if additional security of the shaft is required.

As discussed above, armature assembly 102 includes armature 110. When coil 106 is energized, the armature moves to the right (ref. FIG. 4) and at least a portion of the armature is surrounded by shaft pilot 118. As shown in the example embodiment, shaft pilot 118 includes conical protrusion 142 with conical inner surface 144 and armature 110 includes conical protrusion 146 with conical outer surface 148 disposed proximate conical inner surface 144 when the coil is energized. The armature and shaft pilot are arranged such that the armature contacts the shaft pilot when the coil is energized and the detent solenoid is at its full stroke. The overlapping conical surfaces provide additional magnetic force, enhancing operation of the detent solenoid.

When the coil is energized, the armature assembly is displaced (e.g., to the right in FIG. 4) and the detent is radially displaced out of the groove and rests against the armature assembly. In the embodiments shown, the detent ball rests against a portion of the shaft assembly without the groove, for example. Detent solenoid 100 also includes return spring 150 arranged axially between the armature and the shaft pilot. Return spring 150 is arranged to urge the armature assembly towards a rest position. That is, when the coil is energized, the armature is axially displaced towards the shaft pilot, compressing the return spring between the armature and the shaft pilot, storing energy to be released when the coil is de-energized to move the armature assembly to the left (ref. FIG. 4) towards a rest position where the detent is seated in the groove and the shaft is seated against the housing. Armature 110 and shaft pilot 118 include respective cylindrical depressions 152 and 154, and, in the rest position shown in FIG. 4, for example, length 156 of the return spring is less than distance 158 between the respective cylindrical depressions.

Although only a single detent 108 is shown, other embodiments (not shown) may include multiple detents. For example, detent solenoid 100 may include a second detent disposed circumferentially opposite detent 108 such that respective central axes of the detents are aligned and radial forces from the detents acting on the armature assembly are balanced.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Detent solenoid
102 Armature assembly
104 Groove (armature assembly)
106 Coil
108 Detent
109 Electrical connector
110 Armature
111 Drawn sleeve
112 Shaft
113 Wire coil (coil)
114 Housing
115 Bobbin (coil)
116 Cover plate
118 Shaft pilot
120 Radial hole (shaft pilot)
122 Axially oriented hole (cover plate)
124 Radially extending notch (cover plate)
126 Hole (shaft pilot)
128 Radially outer notch (cover plate)
130 Tab (housing)
132 Detent housing
134 Ball (detent)
136 Spring (detent)
138 Axial side (first, groove)
140 Axial side (second, groove)
142 Conical protrusion (first, shaft pilot)
144 Conical inner surface (first conical protrusion)
146 Conical protrusion (second, armature)
148 Conical outer surface (second conical protrusion)
150 Return spring
152 Cylindrical depression (armature)
154 Cylindrical depression (shaft pilot)
156 Length (return spring)

158 Distance between cylindrical depressions

What is claimed is:

1. A detent solenoid, comprising:
an armature assembly comprising a groove;
a coil arranged for displacing the armature assembly; and
a detent arranged for seating in the groove.

2. The detent solenoid of claim 1 wherein the groove comprises:
a first axial side having a toroidal shape; and
a second axial side, opposite the first axial side, having a conical shape.

3. The detent solenoid of claim 1 wherein:
the armature assembly comprises:
an armature; and
a shaft fixed in the armature; and
the groove is disposed in the shaft.

4. The detent solenoid of claim 3 wherein the armature is made of a ferrous material.

5. The detent solenoid of claim 1, further comprising:
a housing at least partially surrounding the coil;
a cover plate fixed to the housing; and
a shaft pilot fixed to the cover plate, wherein:
the shaft pilot comprises a radial hole; and
the detent is disposed in the radial hole.

6. The detent solenoid of claim 5 wherein:
the cover plate comprises an axially oriented hole with a radially extending notch; and
at least a portion of the detent is disposed in the radially extending notch.

7. The detent solenoid of claim 5 wherein:
the cover plate comprises a radially outer notch; and
the housing comprises a tab folded over the radially outer notch to fix the cover plate to the housing.

8. The detent solenoid of claim 5 wherein the detent comprises:
a detent housing fixed in the radial hole;
a ball disposed in the detent housing; and
a spring arranged to urge the ball into the groove.

9. The detent solenoid of claim 5 wherein:
the armature assembly comprises an armature; and
when the coil is energized, at least a portion of the armature is surrounded by the shaft pilot.

10. The detent solenoid of claim 9 wherein:
the shaft pilot comprises a first conical protrusion with a conical inner surface; and
the armature comprises a second conical protrusion with a conical outer surface disposed proximate the conical inner surface when the coil is energized.

11. The detent solenoid of claim 5 further comprising a return spring, wherein:
the armature assembly comprises an armature;
the return spring is arranged axially between the armature and the shaft pilot; and
the return spring is arranged to urge the armature assembly towards a rest position.

12. The detent solenoid of claim 11 wherein:
the armature and the shaft pilot comprise respective cylindrical depressions; and
in the rest position, a length of the return spring is less than a distance between the respective cylindrical depressions.

13. The detent solenoid of claim 11 wherein, when the coil is energized, the armature is axially displaced towards the shaft pilot, compressing the return spring.

14. The detent solenoid of claim 1 wherein the detent is seated in the groove when the armature assembly is in a rest position.

15. The detent solenoid of claim 14 wherein, when the coil is energized, the armature assembly is displaced and the detent is radially displaced out of the groove and rests against the armature assembly.

16. The detent solenoid of claim 1 further comprising a drawn sleeve fixed in the coil and arranged to guide the armature assembly.

17. The detent solenoid of claim 1 further comprising a second detent, wherein:
the detent and the second detent are disposed circumferentially opposite one another; and
respective central axes of the detent and the second detent are aligned so that radial forces from the detent and the second detent acting on the armature assembly are balanced.
